(19) United States
(12) Patent Application Publication
(10) Pub. No.: US 2022/0253332 A1
(43) Pub. Date: Aug. 11, 2022

(54) OPERATION AUTOMATION SYSTEM OF AUTOMATIC EXECUTION SERVICE AND DISPLAY METHOD OF AUTOMATIC EXECUTION SERVICE

(71) Applicant: Hitachi, Ltd., Tokyo (JP)

(72) Inventors: Kensuke IKEMOTO, Tokyo (JP); Tadashi YAGAME, Tokyo (JP); Hironobu SAKATA, Tokyo (JP)

(73) Assignee: Hitachi, Ltd.

(21) Appl. No.: 17/468,572

(22) Filed: Sep. 7, 2021

(30) Foreign Application Priority Data
Feb. 10, 2021 (JP) 2021-020226

(51) Int. Cl. G06F 9/46; G06F 3/14; G06F 9/445

(52) U.S. Cl. CPC G06F 9/46; G06F 9/44526; G06F 3/14

(57) ABSTRACT

An operation automation system includes an input/output device inputting information for specifying a component of a relation display target in a data processing flow in which a plurality of hierarchies respectively including at least one component are hierarchically configured; and a processor that selects a display mode for performing normal display for a first hierarchy to which the component of the relation display target belongs, selects a display mode for performing simple display for a second hierarchy to which a component including a hierarchy to which the component of the relation display target belongs, and selects a display mode for performing non-display for a third hierarchy but neither the first hierarchy nor the second hierarchy to which the component including the hierarchy to which the component of the relation display target belongs, in the plurality of hierarchies configuring the data processing flow.

### BACKGROUND OF THE INVENTION

### 1. Field of the Invention

The present invention relates to display of an automatic execution service.

### 2. Description of the Related Art

As the background art of this technical field, JP 6154555 B2 is provided. In JP 6154555 B2, it is described that “a management system displays a plurality of processing icons of a plurality of processings included in an automatic execution service on a screen. The management system displays an execution order line that joins the plurality of processing icons and indicates an execution order of the plurality of processings, on the screen. The management system displays a property reference relationship line that joins the plurality of processing icons and indicates a property reference relationship in the plurality of processings, on the screen on which the plurality of processing icons and the execution order line are displayed”.

In JP 6154555 B2 described above, two types of lines of the execution order line that joins the plurality of processing icons and indicates the execution order of the plurality of processings and the property reference relationship line that joins the plurality of processing icons and indicates the property reference relationship in the plurality of processings are displayed, and thus, the visibility of the entire automatic execution service is increased.

However, in a service operation of the recent IT system, data processing flows joined by the execution order line include a hierarchy, in accordance with the complication of the data processing flow for providing a service. For example, in one service, 300 or more components (processing icons) are constructed by a plurality of hierarchies. For this reason, it is difficult for a service constructor (a user) to grasp the reference relationship in the respective components (processings) configuring the large-scale and complicated data processing flow for providing the service, and thus, a lot of time and effort are required to construct the service. In JP 6154555 B2, it has not been considered to check the reference relationship or the like in the processings in the complicated data processing flow including the hierarchy.

### SUMMARY OF THE INVENTION

Therefore, an object of the present invention is to provide a display method of an automatic execution service in which it is possible to check a reference relationship in components (processings) that a user wants to grasp while looking down at the entire service, in a data processing flow including a hierarchy.

In order to attain the object described above, one aspect of an operation automation system of an automatic execution service of the present invention is an operation automation system, including: an input/output device inputting information for specifying a component in a data processing flow in which a plurality of hierarchies that configure the automatic execution service and respectively include at least one component are configured in a multiple-stage hierarchical manner, as a component of a relation display target; and a processor, in which the processor selects a display mode for performing normal display with respect to a first hierarchy when a hierarchy of a processing target is the first hierarchy to which the component of the relation display target belongs, in the plurality of hierarchies configuring the data processing flow, selects a display mode for performing simple display with respect to a second hierarchy when the hierarchy of the processing target is the second hierarchy to which a hierarchy component including a hierarchy to which the component of the relation display target belongsbelongs, in the plurality of hierarchies configuring the data processing flow, and selects a display mode for performing non-display with respect to a third hierarchy when the hierarchy of the processing target is neither the first hierarchy to which the component of the relation display target belongs or the second hierarchy to which the hierarchy component including the hierarchy to which the component of the relation display target belongs, but is the third hierarchy, in the plurality of hierarchies configuring the data processing flow.

According to the present invention, it is possible to check a reference relationship in components of a relation display target, which are components (processings) that a user wants to grasp, while looking down at the entire service.

In addition, according to the present invention, a service constructor that is a user is capable of easily grasping a reference relationship in each component configuring a large-scale and complicated data processing flow for providing a service, and is capable of efficiently constructing the service.

### BRIEF DESCRIPTION OF THE DRAWINGS

FIG. 1 is a diagram illustrating an outline of a data processing flow including a hierarchy that is displayed on a display device of an automatic execution service, according to this embodiment;

FIG. 2 is a block diagram illustrating an outline of a configuration of an automatic execution service system, according to the embodiment;

FIG. 3 is a hardware block diagram of a management server of an operation automation system, according to the embodiment;

FIG. 4 is a hardware block diagram of a management client of the operation automation system, according to the embodiment;

FIG. 5 is a diagram illustrating an example of a service management table 500, according to the embodiment;

FIG. 6 is a diagram illustrating an example of a hierarchical management table 600, according to the embodiment;

FIG. 7 is a diagram illustrating an example of a component management table 700, according to the embodiment;

FIG. 8 is a diagram illustrating an example of a component property management table 800, according to the embodiment;

FIG. 9 is a diagram illustrating an example of a property reference management table 900, according to the embodiment;

FIG. 10 is a diagram illustrating display mode determination processing of a management client 14, according to the embodiment;

FIG. 11 is a diagram illustrating simple display component extraction processing of the management client 14, according to the embodiment;

FIG. 12 is a flow illustrating the details of step S1103 in FIG. 11 and is a diagram illustrating determination processing of a display condition 1;

FIG. 13 is a flow illustrating the details of step S1105 in FIG. 11 and is a diagram illustrating determination processing of a display condition 2;

FIG. 14 is a flow illustrating the details of step S1106 in FIG. 11 and is a diagram illustrating determination processing of a display condition 3;

FIG. 15 is a flow illustrating the details of step S1107 in FIG. 11 and is a diagram illustrating determination processing of a display condition 4;

FIG. 16 is a diagram illustrating an example of the automatic execution service; and

FIG. 17 is a diagram illustrating a display example in a case where this example is applied to the data processing flow of the automatic execution service illustrated in FIG. 16.

### DETAILED DESCRIPTION OF THE PREFERRED EMBODIMENTS

In the following description, a processing unit includes one or more processors. Typically, at least one processor may be a micro processor such as a central processing unit (CPU), or may be other types of processors such as a graphics processing unit (GPU). At least one processor may be a single-core, or may be a multi-core.

In addition, at least one processor may be a processor in a broad sense, such as a hardware circuit (for example, a field-programmable gate array (FPGA) or an application specific integrated circuit (ASIC)) performing a part of processing or the entire processing.

In addition, in the following description, information in which output is obtained with respect to input may be described by the expression of “xxx table”, and the information may be data having any structure. Accordingly, the “xxx table” can be referred to as “xxx information”.

In addition, in the following description, the configuration of each table is an example, and one table may be divided into two or more tables, or all or a part of two or more tables may be one table.

In addition, in the following description, processing may be described by using a “program” as a subject, but the program is executed by a processor such that set processing is performed while suitably using a memory unit and/or an interface unit, and thus, the subject of the processing may be the processor (or a device such as a controller including the processor).

The program may be installed in a device such as a calculator, and for example, may be a (for example, non-transient) recording medium that can be read by a program distribution server or a calculator. In addition, in the following description, two or more programs may be attained as one program, or one program may be attained as two or more programs.

In addition, a calculator system may be a dispersion system including one or more (typically, a plurality of) physical node devices. The physical node device is a physical calculator.

In addition, in the following description, an identification number is used as identification information of various targets, but other types of identification information items (for example, an identifier including alphabetical characters or signs) in addition to the identification number may be adopted.

In addition, in the following description, in a case where the same type of elements are described without being discriminated, reference numerals (or common numerals in the reference numerals) may be used, and in a case where the same type of elements are described by being discriminated, identification numbers (or the reference numerals) of the elements may be used.

### EXAMPLE

As a technology for easily designing data processing, a technology for creating data processing as a flow is provided. In this technology, an input/output destination of data or individual processing for processing or converting data (hereinafter, referred to as a “service”) is defined as a data processing flow. A creating of the data processing flow, for example, creates a processing order of data as a flow by linking components in which each processing is executed with a directed edge, on a graphical user interface (GUI). An execution unit of the data processing flow calls each service in accordance with the order of the data processing flow, and sets an instruction for the data processing or an input/output destination of the data such that the data processing proceeds.

<Definition of Term>

Here, terms used in an example will be defined as follows.

A “data processing flow” is a flow in which an execution order of a plurality of components is defined in order to construct an automatic execution service.

A “component” is a processing icon that can be included in an automatic execution service.

A “service” is a data processing flow in which a plurality of components are connected in order to attain automatic execution.

“Processing” is a constituent of an automatic execution service and is procedure unit to be executed by a processing icon.

A “component property” is an input value (an input property) and an output value (an output property) at the time of processing execution of a component.

A “relation” or a “reference relationship” is a relationship in which data passing is performed between components. In addition, the “relation” or the “reference relationship” is a relationship in which data referred to as an input property and an output property between the components. The relation or the reference relationship may be referred to as property mapping, an input property side may be referred to as a property mapping destination, and an output property side may be referred to as a property mapping source.

“Reference destination information” is a property value of the other component that is referred to as an input value at the time of processing execution of a component.

A “hierarchy” is a field in which a component can be disposed, and a specific component includes a hierarchy. An automatic execution service has a multiple-stage hierarchy structure in which a plurality of hierarchies are hierarchically constructed by disposing components including hierarchies.

<Outline of Automatic Execution Service>

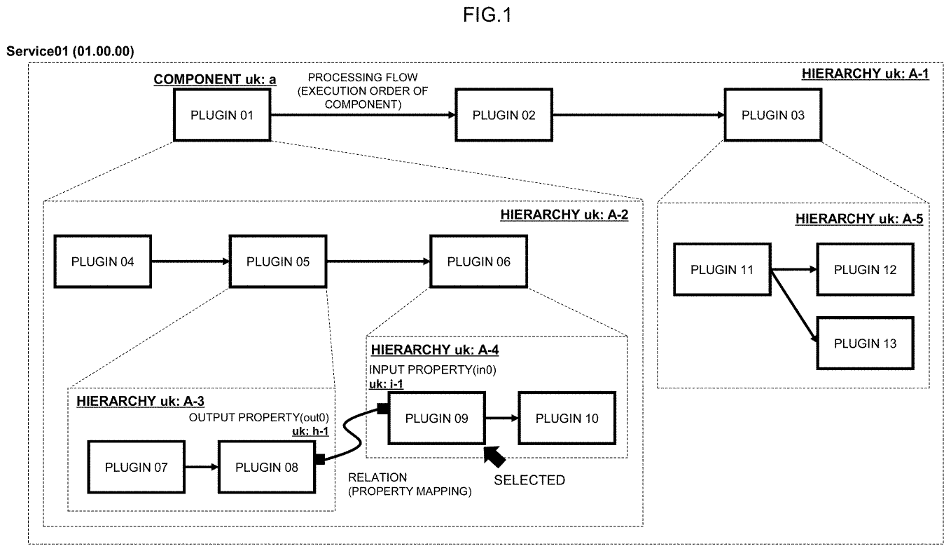

FIG. 1 illustrates the outline of a data processing flow of an automatic execution service including a hierarchy that is displayed on a display device of an operation automation system, which is a target of this embodiment.

FIG. 1 illustrates a data processing flow in which components represented by a plugin 01 (Plugin01) to a plugin 13 (Plugin13) are processed in an order represented by an arrow, as one automatic execution service. Such a data processing flow configures a service 01 (Service01) of the automatic execution service.

The uppermost root hierarchy (a hierarchy A-1) includes three components of the plugin 01 to the plugin 03.

A hierarchy A-2 includes components of the plugin 04 to the plugin 06, as a lower hierarchy of the plugin 01 that is the component of the hierarchy A-1. The plugin 05 and the plugin 06 are a component including a lower hierarchy.

A hierarchy A-3 includes the plugin 07 and the plugin 08, as a lower hierarchy of the plugin 05 that is the component of the hierarchy A-2.

A hierarchy A-4 includes components of the plugin 09 and the plugin 10, as a lower hierarchy of the plugin 06 that is the component of the hierarchy A-2.

A hierarchy A-5 includes components of the plugin 11 to the plugin 13, as a lower hierarchy of the plugin 03 that is the component of the hierarchy A-1.

An object of this example is to provide an operation automation system of an automatic execution service and a display method of an automatic execution service in which, as illustrated in FIG. 1, even in a case where a data processing flow of the automatic execution service has a multiple-stage hierarchy structure, necessary information relevant to the outline or the relativeness of processing in the data processing flow remains with respect to a specific component, and it is possible to check a reference relationship relevant to a component of a relation display target while looking down at the entire data processing flow. For example, as illustrated in FIG. 1, in the data processing flow of the automatic execution service, in the case of planning to refer to relation information of the plugin 09 that is the component of the hierarchy A-4, the hierarchy A-5 that is a hierarchy having no relationship after grasping the reference relationship is subjected to non-display, and the hierarchy A-2 including the plugin 05 and the plugin 06 and the upper hierarchy A-1 thereof are subjected to simple display in which a component required to grasp the outline of a hierarchy relationship or the processing is displayed by being extracted, and thus, it is possible to check the reference relationship relevant to the component of the relation display target while looking down at the entire data processing flow.

<System Configuration>

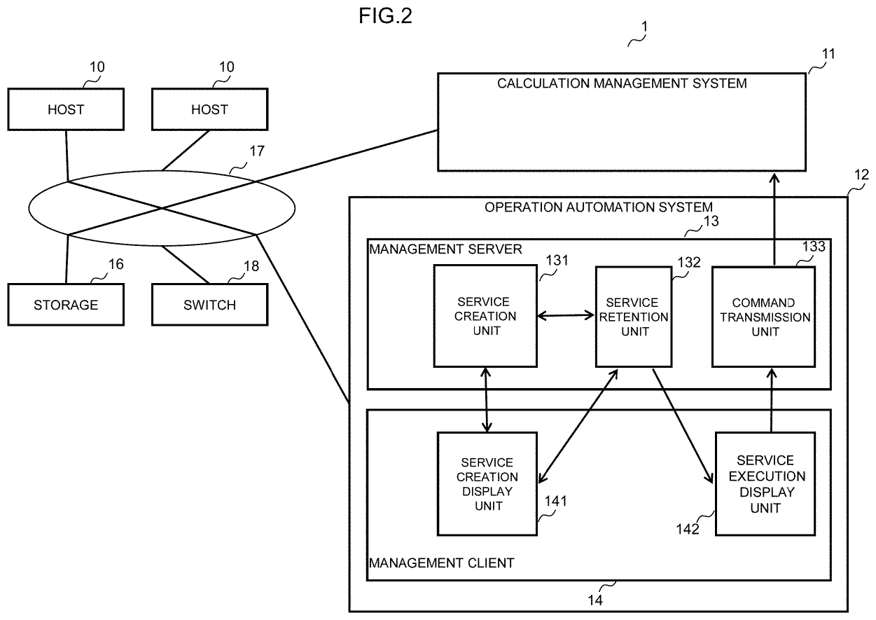

FIG. 2 is a block diagram illustrating the outline of the configuration of an automatic execution service system 1 according to an embodiment. As illustrated in FIG. 2, the automatic execution service system 1 includes a network 17, a plurality of hosts 10 that are respectively connected to the network 17, a calculation management system 11, an operation automation system 12, a storage 16, and a switch 18. The calculation management system 11 sets or controls the configuration of the host 10, the storage 16, and the switch 18.

The operation automation system 12 includes a management server 13 and a management client 14, and the management server 13 includes a service creation unit 131 that creates or edits the automatic execution service, a service retention unit 132 that retains the service created or edited by the service creation unit 131, and a command transmission unit 133 that transmits the service retained by the service retention unit 132 to the calculation management system 11.

The management client 14 includes a service creation display unit 141 for creating or editing the automatic execution service, and a service execution display unit 142 that actually commands the calculation management system 11 and displays the service to be executed by the host 10, the storage 16, and the like.

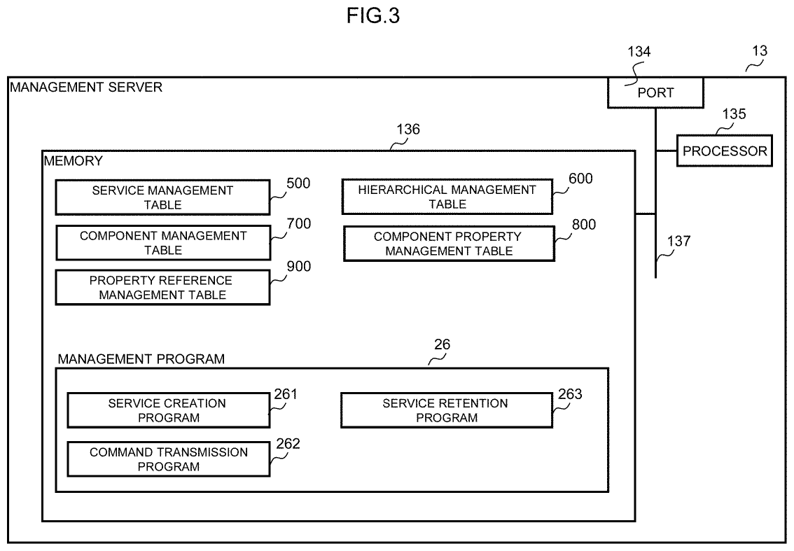

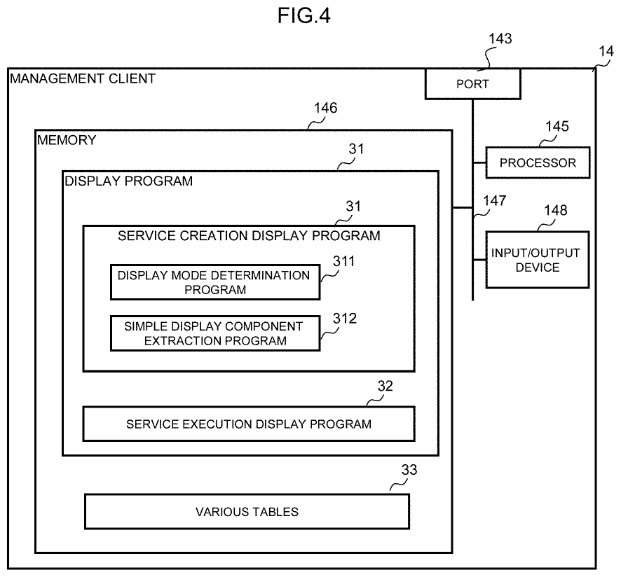

The configuration of the management server 13 will be described in detail by using FIG. 3, and the configuration of the management client will be described in detail by using FIG. 4.

FIG. 3 is a hardware block diagram of the management server 13. As with a general calculator, the management server 13 includes a memory 136 including a volatile memory element such as a RAM, a processor 135 that executes a program by reading the program to the memory 136, performs overall control of the device itself, and performs various determinations, arithmetic operations, and control processings, a port 134 that is an interface for transmitting or receiving data with respect to the other device such as the management client 14 or the calculation management system 11, and a bus 137 that connects the processor 135, the memory 136, and the like to each other.

The memory 136 stores various tables of a service management table 500, a hierarchical management table 600, a component management table 700, a component property management table 800, and a property reference management table 900. The various tables will be described below.

In addition, the memory 136 stores a service creation program 261 for creating or editing the automatic execution service, a service retention program 263 for retaining the automatic execution service that is created by the service creation program 261 in the memory 136, and a command transmission program 262 for transmitting the automatic execution service that is created by the service creation program 261 and is retained by the service retention program 263 to the calculation management system 11. The processor 135 executes various programs stored in the memory 136, and thus, attains various functions.

FIG. 4 is a hardware block diagram of the management client 14. As with a general calculator, the management client 14 includes a memory 146 including a volatile memory element such as a RAM, a processor 145 that executes a program by reading the program to the memory 146, performs overall control of the device itself, and performs various determinations, arithmetic operations, and control processings, a port 143 that is an interface for transmitting or receiving data with respect to the other device such as the management server 13 or the calculation management system 11, an input/output device 148 such as an input device inputting data from a user, such as a keyboard or a mouse, and an output device outputting data to the user, such as a display device, and a bus 147 that connects the processor 145, the memory 146, and the like to each other.

The memory 146 stores a service creation display program 31, and a service execution display program 32 for displaying the created automatic execution service on the input/output device 148. The service creation display program 31 includes a display mode determination program 311 for attaining a display determination algorithm of this embodiment, and a simple display component extraction program 312 for attaining an algorithm that extracts the component for simple display included in the hierarchy.

The management client 14 includes a storage area 33 for various tables in which the data required for the processing that is received from the management server 13 is stored. Examples of the data required for the processing include at least a part of the data in the service management table 500, the hierarchical management table 600, the component management table 700, the component property management table 800, and the property reference management table 900.

<Various Tables (Various Information Items)>

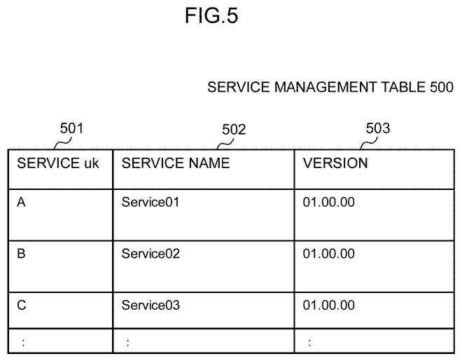

FIG. 5 is a diagram illustrating an example of the service management table 500. In the service management table 500, a service uk 501, a service name 502, and a version 503 are managed in association with each other. The service uk is a service unique key and is information for identifying the service. The service uk can be replaced with a service ID. Hereinafter, any uk in this specification may be replaced with ID.

In FIG. 5, for example, it is illustrated that the service uk of “A” is the service name of “Service01” and the version of “01.00.00”.

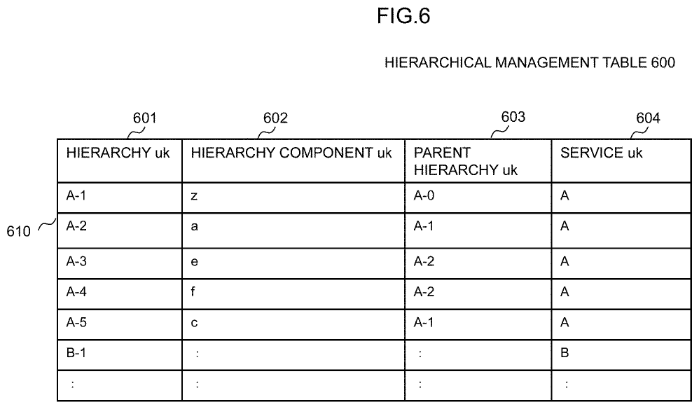

FIG. 6 is a diagram illustrating an example of the hierarchical management table 600. In the hierarchical management table 600, a hierarchy uk 601, a hierarchy component uk 602, a parent hierarchy uk 603, and a service uk 604 are managed in association with each other. The service uk 604 is information corresponding to the service uk 501 of the service management table 500 in FIG. 5.

The hierarchy uk 601 is information for identifying the hierarchy. The hierarchy component uk 602 is information for identifying a component for grouping the hierarchy to be identified by the hierarchy uk 601. The hierarchy component uk 602 includes the hierarchy uk and is information for specifying a component belonging to an upper hierarchy of the hierarchy uk. The parent hierarchy uk 603 is information for identifying a parent hierarchy (also referred to as the upper hierarchy) of the hierarchy to be identified by the hierarchy uk 601. The service uk 604 is information for identifying the service included in the hierarchy to be identified by the hierarchy uk 601.

For example, in an entry 610, the hierarchy uk 601 is identified as “A-2”, and a hierarchy component that includes the hierarchy of “A-2” and belongs to an upper hierarchy (A-1) is “a”. In addition, the parent hierarchy 603 of the hierarchy A-2 is “A-1”, and the hierarchy A-2 is a hierarchy configuring the service of “A”.

Note that, there is no upper hierarchy of the hierarchy A-1, and thus, “A-0” is registered in the parent hierarchy uk, as the value of null, and there is no hierarchy component uk, and thus, “z” is registered as the value of null.

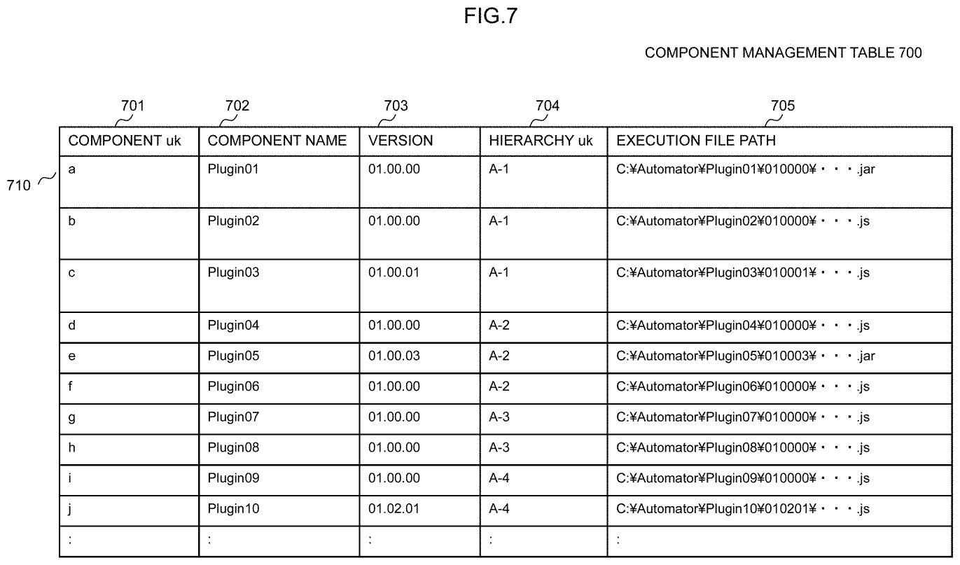

FIG. 7 is a diagram illustrating an example of the component management table 700. In the component management table 700, a component uk 701, a component name 702, a version 703, a hierarchy uk 704, and an execution file path 705 are managed in association with each other. The hierarchy uk 704 is information corresponding to the hierarchy uk 601 of the hierarchical management table 600 in FIG. 6.

The component uk 701 is information for identifying the component, and the component name 702 is a name applied to the component. The version 703 is information for specifying the version of the component, the hierarchy uk 704 is information for specifying the hierarchy to which the component belongs, and the execution file path 705 is an execution file path for executing the component.

For example, in an entry 710, the component uk 701 is “a”, the component name 702 is “Plugin01”, the version 703 is “01.00.00”, the hierarchy uk 704 is “A-1”, and the execution file path 705 is “:\Automator\Plugin01\010000\^{. . .} .jar”.

According to the component management table 700, the component name and the hierarchy to which the component belongs can be grasped for each of the components, and a processing content of the component can be grasped by the execution file path.

In a case where the service is specified, the management server 13 is capable of grasping the component configuring the specified service or the data processing flow for attaining the service, with reference to the service management table 500 in FIG. 5, the hierarchical management table 600 in FIG. 6, and the component management table 700 in FIG. 7.

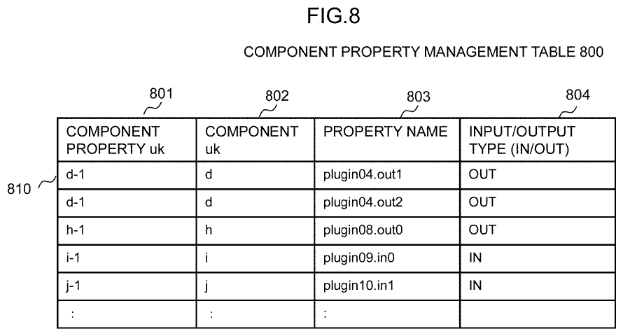

FIG. 8 is a diagram illustrating an example of the component property management table 800. In the component property management table 800, a component property uk 801, a component uk 802, a property name 803, and an input/output type 804 are managed in association with each other. The component uk 802 is information corresponding to the component uk 701 of the component management table 700 in FIG. 7.

The component property uk 801 is information for specifying a component property, and as with the component uk 701 of the component management table 700, the component uk 802 is information for specifying the component. The property name 803 is information for specifying the component name and an input/output path of the component property. The input/output type 804 indicates whether the component property is input or output.

For example, in an entry 810, the component property uk 801 is specified as “d-1”, the component uk 802 is “d”, the property name 803 is “plugin04.out1”, and the input/output type 804 is “OUT”.

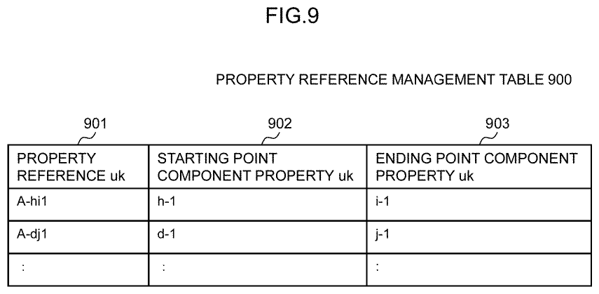

FIG. 9 is a diagram illustrating an example of the property reference management table 900. In the property reference management table 900, a property reference uk 901, a starting point component property uk 902, and an ending point component property 903 are managed in association with each other. The starting point component property uk 902 and the ending point component property 903 are information corresponding to the component property uk 801 of the component property management table 800 in FIG. 8.

The property reference uk 901 is information that is capable of specifying a component having a “relation”, that is, a reference relationship between components. The starting point component property uk 902 indicates a property for passing a value, that is, a property of a component of a mapping source. The ending point component property 903 indicates a property for receiving a value, that is, a property of a component of a mapping destination.

For example, the property reference uk 901 of “A-hi1”, the starting point component property uk 902 of “h-1”, and the ending point component property 903 of “i-1” are checked. In the case of referring to the component property management table 800, it can be grasped that the component uk of the starting point component property uk 902 of “h-1” is “h”, and in the case of referring to the component management table 700, it can be grasped that the component name 702 of the component uk of “h” is “Plugin08”. Similarly, in the case of referring to the component property management table 800, it is can be grasped that the component uk of the ending point component property uk 903 of “i-1” is “i”, and in the case of referring to the component management table 700, it can be grasped that the component name 702 of the component uk of “i” is “Plugin09”. In the case of illustrating such a relationship in FIG. 1, a component such as the plugin 08 of the hierarchy A-3 and the plugin 09 of the hierarchy A-4 are in the reference relationship, and are managed by the property reference management table 900.

<Processing Flow>

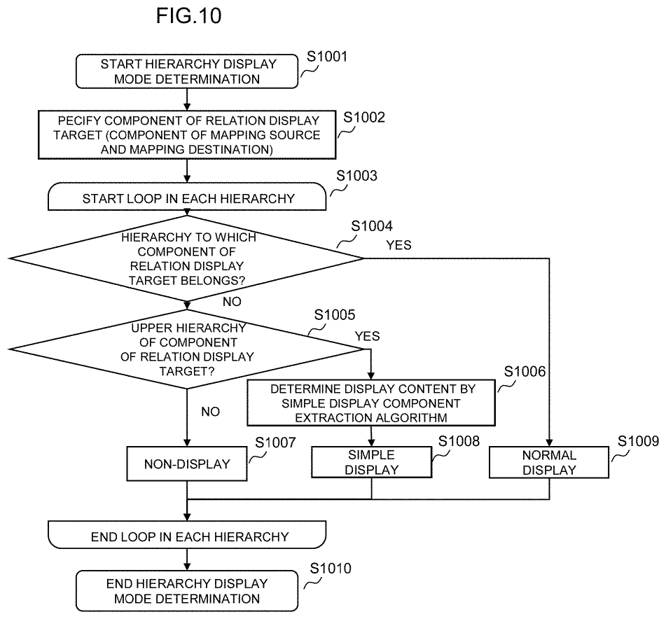

FIG. 10 is a diagram illustrating display mode determination processing to be executed by the processor 145 executing the display mode determination program 311 of the management client 14.

First, the service uk, the service name, or the like is input to the management client 14 from the input/output device 148, as information for specifying a service that is a processing target. In a case where the service that is the processing target is specified, the data required for the processing relevant to the specified service in the service management table 500, the hierarchical management table 600, the component management table 700, the component property management table 800, and the property reference management table 900 is transmitted to the management client 14 from the management server 13, and is stored in the storage area 33 for various tables illustrated in FIG. 4.

In a case where the service is specified, determination processing of a hierarchy display mode is started (step S1001). The operation so far is also attained in the existing automatic execution service system, and thus, the description will be omitted.

The following processing will be described while suitably referring to FIG. 1.

In step S1002, the component of the relation display target of which the reference relationship is planned to be grasped is specified. In FIG. 1, an example is illustrated in which the plugin 09 of the hierarchy A-4 is selected as the component of the relation display target. At this time, the plugin 08 that is a mapping source of the plugin 09 is also grasped on the basis of the property reference management table 900. Even in a case where the plugin 08 is selected, the plugin 09 is also grasped as a mapping destination.

In step S1003, a loop is started in each of the hierarchies. In this example, the service 01 illustrated in FIG. 1 is selected, and thus, a loop is started with respect to all hierarchies belonging to the service described above.

In step S1004, it is determined whether or not a hierarchy of a processing target is a hierarchy to which the component of the relation display target belongs, in the case of YES, the processing proceeds to step S1009, and a mode for performing the normal display with respect to the hierarchy is selected. In the determination of step S1004, in a case where a record in which the component uk that is the component of the relation display target specified in step S1002 includes the hierarchy uk that is a loop processing target of step S1003 is in the component management table 700, with reference to the component management table 700, it is determined as YES. That is, it is can be grasped that the plugin 09 belongs to the hierarchy A-4, with reference to the component management table 700, and in a case where the hierarchy of the processing target is the hierarchy A-4, it can be determined whether or not the component uk of the plugin 09 is the hierarchy A-4. The hierarchy A-4 to which the plugin 09 that is the component of the relation display target belongs is subjected to the normal display, and as illustrated in FIG. 1, the “normal display” is performed in which the plugin 10 that is the other component belonging to the hierarchy A-4 is also displayed.

In a case where the determination of step S1004 is NO, the processing proceeds to step S1005, and it is determined whether or not the hierarchy of the processing target is the upper hierarchy of the component of the relation display target, and in a case where the hierarchy of the processing target is the upper hierarchy, the processing proceeds to step S1006, and the hierarchy that is a processing target is subjected to the “simple display”, and in a case where the hierarchy of the processing target is not the upper hierarchy, the processing proceeds to step S1007, and the hierarchy that is the processing target is subjected to the “non-display”.

In this example, the hierarchy A-2 is the upper hierarchy of the hierarchy A-4 including the selected plugin 09, and thus, is subjected to the “simple display”, on the basis of the hierarchical management table 600. Similarly, the hierarchy A-1 is also subjected to the “simple display”. The hierarchy A-5 is not the upper hierarchy of the hierarchy A-4, and thus, is subjected to the “non-display”.

The plugin 08 belonging to the hierarchy A-3 is a component in the reference relationship with the selected plugin 09, and thus, is treated as with the plugin 09 that is the component of the relation display target. That is, in step S1004, the hierarchy A-3 is also determined as a hierarchy including the component of the relation display target (the plugin 08), the processing proceeds to step S1009, and the mode for performing the “normal display” is selected.

In the “normal display”, a screen of the data processing flow at the time of a service creation or editing is displayed. In the “normal display”, the shape of a disposition location of the flow is also important information, and a hierarchy required to be coincident with when the flow is created is a target such that the reference relationship can be reliably checked without an error. A hierarchy to which a component that is a property mapping source and a property mapping destination of the component of the relation display target belongs is a normal display target. The screen of the data processing flow may be read out from the service retention unit 132.

In the “simple display”, the hierarchy relationship (an absolute/relative path) and a processing order relationship are represented, information such as the component is extracted such that the outline of the processing is grasped, and a hierarchy from which unnecessary information is decimated is displayed. Note that, a display method may be a format in which the component names are linked by an arrow. Basically, the upper hierarchy of the hierarchy to which the component of the property mapping source and the property mapping destination of the component of the relation display target belongs is a target.

In the “non-display”, the hierarchy has no relationship after grasping the reference relationship, and has a noise even in the case of being displayed, and thus, is not displayed.

In step S1005, the “hierarchy uk” to which the component of the relation display target specified in step 1002 belongs is specified in accordance with the component management table 700. After that, all of the “parent hierarchies uk” (the upper hierarchies) are specified with respect to the “hierarchy uk” described above, in accordance with the hierarchical management table 600. In this example, the hierarchy A-4 to which the plugin 09 belongs is specified in accordance with the component management table 700, and the upper hierarchy A-1 is further specified with reference to the hierarchical management table 600, in addition to the upper hierarchy A-2 or the upper hierarchy A-2 of the hierarchy A-4. In a case where the loop processing of step S1005 is performed by using the hierarchy A-2 or the hierarchy A-1 as a target, the hierarchy A-2 or the hierarchy A-1 is determined as the upper hierarchy.

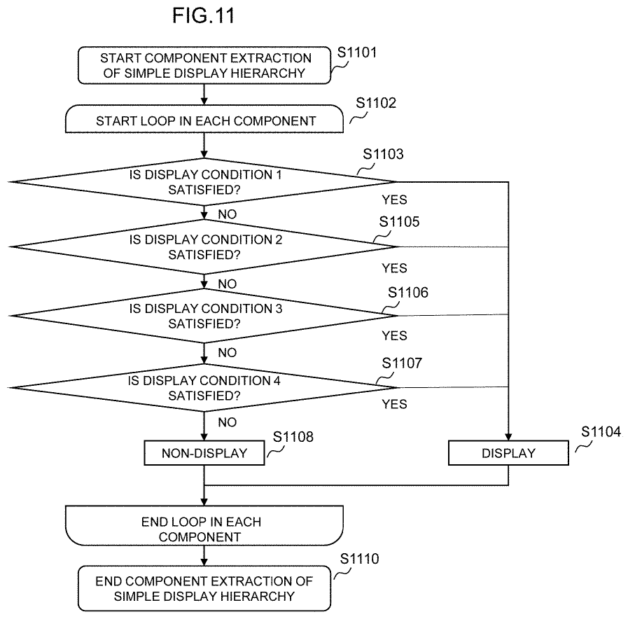

The processing proceeds to step S1006, and thus, the hierarchy of the processing target that is determined as the upper hierarchy is subjected to information extraction processing for the simple display described below by using FIG. 11 to FIG. 15.

In the management client 14, in a case where the processor 145 selects the display modes of the “non-display”, the “simple display”, and the “normal display” with respect to each of the hierarchies, by the processing illustrated in FIG. 10, each of the displays is displayed on the display device of the input/output device 148, or the like.

In this embodiment, in order for the user creating the automatic execution service to check the relation while looking down at the entire data processing flow without being aware of the processing order or the hierarchy, the display mode such as the “normal display”, the “simple display”, and the “non-display” is selected and switched in accordance with the hierarchy, in relation to the hierarchy to which the component of the relation display target of which the reference relationship is planned to be grasped belongs.

Next, the extraction of the information in the case of the simple display will be described by using FIG. 11 to FIG. 15.

FIG. 11 is a diagram illustrating processing that is performed by the processor 145 executing the simple display component extraction program 312 of the service creation display program 31, in the management client 14.

In step S1101, component extraction of a simple display hierarchy is started.

Next, in step S1102, the loop processing is started with each of the components included in the hierarchy that is the processing target. For example, in a case where the hierarchy of the processing target (a processing hierarchy) is the hierarchy A-1 in FIG. 1, the loop processing is performed with each of the plugin 01, the plugin 02, and the plugin 03.

In step S1103, it is determined whether or not a “display condition 1” is satisfied, and in a case where the condition is satisfied, the processing proceeds to step 1104. In step S1104, the component that is the processing target is extracted and displayed.

Note that, the “display condition 1” is a condition in which the component of the processing target is a component for grouping the hierarchy to which the component of the relation display target belongs. The component for grouping the hierarchy can be restated in the component belonging to the upper hierarchy configuring the hierarchy including the component of the relation display target.

In step S1103, in a case where the component of the processing target does not satisfy the display condition 1, the processing proceeds to step S1105, and it is determined whether or not a “display condition 2” is satisfied, and in a case where the condition is satisfied, the processing proceeds to step S1104 of displaying the component of the processing target, and the component that is the processing target is extracted and displayed. In a case where the condition is not satisfied, the processing proceeds to step S1106.

Note that, the “display condition 2” is a condition in which the component of the processing target is a component that is connected to a relevant product (a Web service). Note that, the component satisfying the display condition 2 is a component executing API (other than GET) or a command. In order to grasp the outline of the processing, it is sufficient to extract a component manipulating the relevant product, and the component corresponds to a component executing API such as POST, PUT, and DELETE. This can be determined by the execution file path 705 of the component management table 700.

In step S1106, it is determined whether or not the component of the processing target satisfies a “display condition 3”, and in a case where the condition is satisfied, the processing proceeds to step 1104, and the component that is the processing target is extracted and displayed. In a case where the condition is not satisfied, the processing proceeds to step S1107.

Note that, the “display condition 3” is a condition in which the component of the processing target is a hierarchy component including a hierarchy that includes the component satisfying the display condition 2 in the lower hierarchy (also including two or less stages). For example, the component of the processing target is the plugin 12, and in a case where the plugin 12 is the component satisfying the display condition 2, the plugin 03 that is the hierarchy component of the hierarchy including the plugin 12 is extracted by the display condition 3.

In step S1107, it is determined whether or not a “display condition 4” is satisfied, and in a case where the condition is satisfied, the processing proceeds to step 1104, and the component that is the processing target is extracted and displayed. In a case where the condition is not satisfied, the processing proceeds to step S1108, and the component of the processing target is subjected to the non-display.

Note that, the “display condition 4” is a condition in which the component of the processing target is a component that is referred to by the other component of the hierarchy to which the component of the relation display target belongs or refers to the other component of the hierarchy to which the component of the relation display target belongs. In “Display condition 4”, it may not be possible to determine what the hierarchy is for by the hierarchy to which the components of the relation display target (both the reference source and the reference destination) belong , and thus, the component relevant to the hierarchy (including the hierarchy component) is also displayed.

In a case where the processing is ended with respect to all of the components belonging to the hierarchy to be subjected to the simple display, the component extraction of the simple display hierarchy is ended (S1110). In a case where there are a plurality of hierarchies to be subjected to the simple display, the processing illustrated in FIG. 11 is performed for each of the hierarchies.

Note that, in the display condition 1 and the display condition 4, the component required to grasp the relation (the reference relationship) with respect to the component of the relation display target can be extracted, and the display condition 2 and the display condition 3 correspond to a condition in which the component required to grasp the outline of the processing corresponds is extracted, in the data processing flow configuring the service of the processing target.

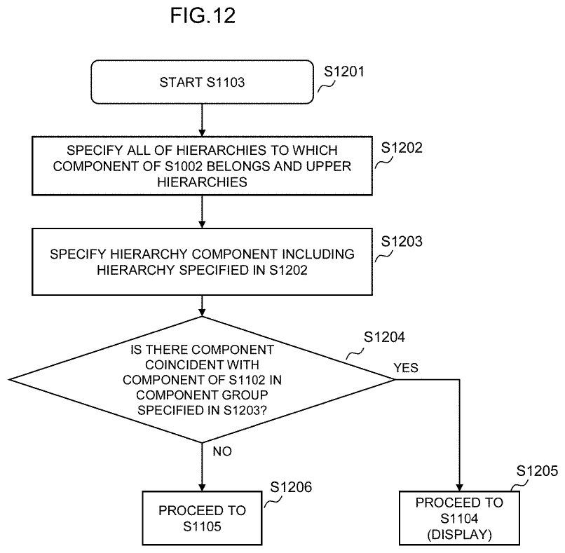

FIG. 12 is a flow illustrating the details of step S1103 in FIG. 11 and is a diagram illustrating the determination processing of the display condition 1.

In step S1201, the processing of step S1103 is started.

In step S1202, all of the hierarchies to which the component specified in step S1002 (the component of the relation display target) belongs and the upper hierarchies are specified. As described in step S1005, such specification is performed with reference to the hierarchical management table 600 and the component management table 700.

In step S1203, a hierarchy component creating each of the hierarchies specified in step S1202 is specified. Such processing can be performed with reference to the hierarchy component 602 of the hierarchical management table 600. For example, in FIG. 1, the hierarchy component creating the hierarchy A-4 is the plugin 06. It can be grasped that the hierarchy component of the hierarchy A-4 is “f” in accordance with the hierarchical management table 600, and it is found that the component of “f” is the component name of “plugin 06”, with reference to the component management table 700.

In step S1204, it is determined whether the component of step S1102, that is, the component that is the processing target is included in a component group specified in step S1203, and in a case where the component is included in the component group, the processing proceeds to step S1205, and the component that is the processing target is displayed. In a case where the component is not included in the component group, the processing proceeds to step S1206, and step S1105 is performed. The determination of the display condition 1 is ended, and the processing proceeds to determination processing of the display condition 2.

Note that, in step S1204, for example, in a case where the component of the processing target is the plugin 01, it can be grasped that the component uk is “a” from the component management table 700. In addition, it can be grasped that the component of “a” is a hierarchy component for grouping the hierarchy A-2, in accordance with the hierarchical management table 600.

According to the processing in FIG. 12, the component of the processing target is the hierarchy component, that is, the component including the lower hierarchy, and in a case where the component of the relation display target exists in the lower hierarchy, the component of the relation display target is extracted as the component that is displayed in the simple display.

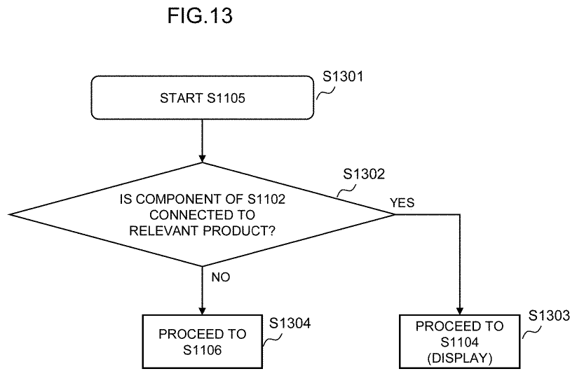

FIG. 13 is a flow illustrating the details of step S1105 in FIG. 11 and is a diagram illustrating the determination processing of the display condition 2.

In step S1301, the processing of step S1105 is started.

In step S1302, it is determined whether or not the component that is the processing target in step S1102 is connected to the relevant product. In a case where the component is connected to the relevant product, the processing proceeds to step S1303, and the component of the processing target is extracted and displayed. On the other hand, in a case where the component is not connected to the relevant product, the processing proceeds to step S1304, and the processing of step S1106 is performed. The determination of the display condition 2 is ended, and the processing proceeds to the determination of the display condition 3.

The determination of step S1302, that is, the determination of whether or not the component is connected to the relevant product can be performed by checking the content of the execution file path 705 of the component management table 700. For example, it is checked whether or not there is a command issued by API with respect to the calculation management system 11 (refer to FIG. 2), and the like, in a script such as Javascript.

According to the processing in FIG. 13, it is determined whether or not the component of the processing target is connected to the relevant product, and the component that is connected to the relevant product is extracted and displayed.

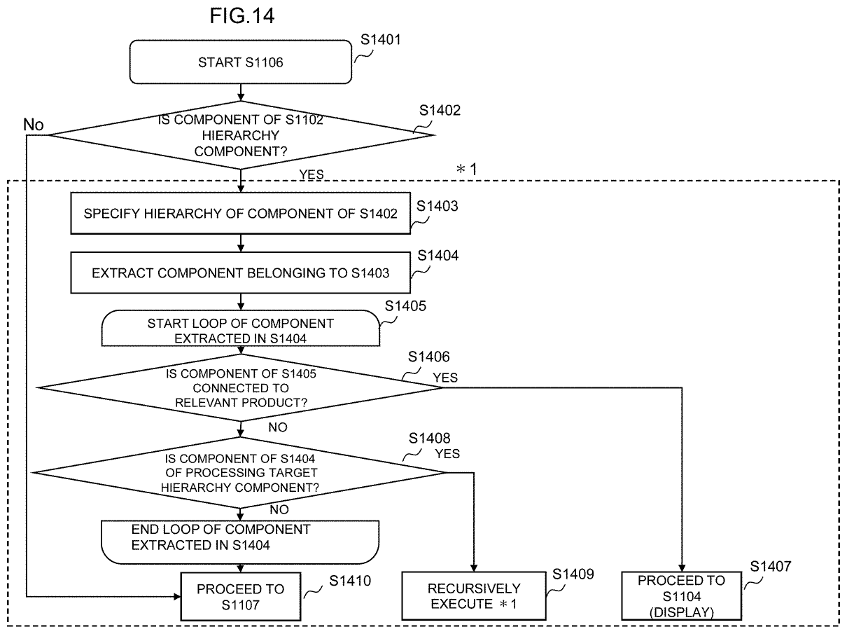

FIG. 14 is a flow illustrating the details of step S1106 in FIG. 11 and is a diagram illustrating the determination processing of the display condition 3.

In step S1401, the processing of step S1106 is started.

In step S1402, it is determined whether or not the component that is the processing target in step S1102 is the hierarchy component, and in a case where the component is not the hierarchy component, the processing proceeds to step S1410, and in a case where the component is the hierarchy component, the processing proceeds to step S1403. The determination of step S1402 is performed by checking whether or not the component uk that is the component of the relation display target exists as the hierarchy component uk 602 of the hierarchical management table 600. In step S1410, the processing of step S1107 in FIG. 11 is performed.

In step S1403, the hierarchy of the hierarchy component, that is, the lower hierarchy is specified with reference to the hierarchical management table 600.

In step S1404, the component belonging to the hierarchy (the lower hierarchy) specified in step S1403 is extracted with reference to the component management table 700.

In step S1405, the loop processing is started with the component extracted in step S1404.

In step S1406, it is determined whether or not the component that is the loop processing target is connected to the relevant product. Such determination is the same processing as that of step S1302. In a case where the component of the processing target is connected to the relevant product, in step S1407, the component of the processing target that is a loop target in S1102 is a display target. That is, the component of S1102 that is determined as the hierarchy component in S1402 is extracted as the component including the component that is connected to the relevant product (the Web service) in the lower hierarchy is displayed. In a case where the component is not connected to the relevant product, the processing proceeds to step S1408.

In step S1408, it is determined whether or not the component that is the loop processing target is the hierarchy component, with reference to the hierarchical management table 600. The processing content of step S1408 is the same as that of step S1402. In a case where the component is the hierarchy component, the processing subsequent to step S1403 is recursively executed (S1409).

In a case where the processing is performed with respect to all of the components that are included in the hierarchy, the processing proceeds to step S1410, and the processing of step S1107 in FIG. 11 is performed. That is, the determination of the display condition 3 is ended, and the processing proceeds to the determination of the display condition 4.

According to the processing in FIG. 14, the hierarchy component that includes the component satisfying the display condition 2 in the lower hierarchy, which is the determination of the display condition 3, is extracted.

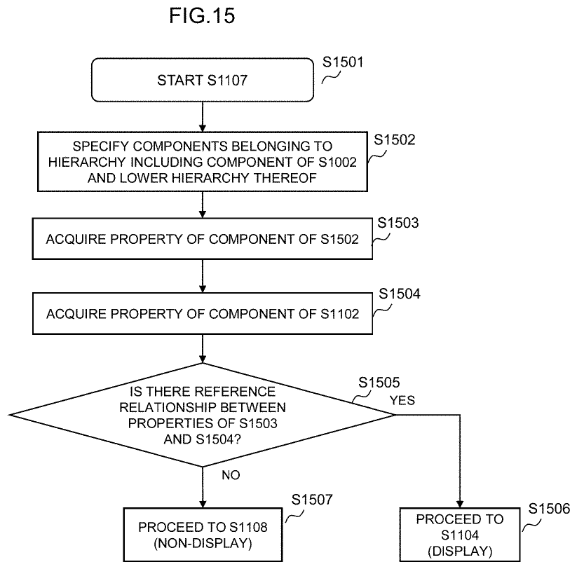

FIG. 15 is a flow illustrating the details of step S1107 in FIG. 11 and is a diagram illustrating the determination processing of the display condition 4.

In step S1501, the processing of step S1107 is started.

In step S1502, the components belonging to the hierarchy including the component of the relation display target and the lower hierarchy are specified.

In the specification of the component belonging to the target hierarchy, the “hierarchy uk” is specified with respect to the “component uk” of the component specified in step S1002 of FIG. 10, in accordance with the component management table 700. After that, the component uk of the other component belonging to the specified hierarchy uk is specified with reference to the component management table 700.

In the specification of the component belonging to the lower hierarchy, the hierarchy that is managed corresponding to the “parent hierarchy uk” of the hierarchical management table 600 is extracted, and the “hierarchy uk” thereof is specified. For example, the hierarchy A-3 and the hierarchy A-4 are specified as the lower hierarchy, with respect to the parent hierarchy A-2. After that, a record including the above in the “hierarchy uk” of the component management table 700 is extracted, and the “component uk” is specified. The above is repeated, and thus, the lower hierarchy extending into a multiple-stage hierarchy can be specified, and the component belonging to the lower hierarchy can be specified.

In step S1503, the property of the component specified in step S1502 is acquired. In the component property management table 800, the component property uk that is managed corresponding to the component uk is acquired as the property of the component. For example, in a case where the component uk is “d”, component property uk of “d-1”, the property name of “plugin04.out1” or the like is acquired as the property of the component, with reference to the component property management table 800.

Next, in step S1504, the property of the component in step S1102 (the component of the relation display target) is acquired. The “component property uk” corresponding to the component uk is acquired with reference to the component property management table 800.

In step S1505, it is determined whether or not there is a reference relationship between the component property acquired in step 1503 and the component property acquired in step S1504. Whether or not the component properties are in the reference relationship is determined by whether or not the correspondence relationship is managed as the starting point component property 902 and the ending point component property 903 in the property reference management table 900 of FIG. 9. In a case where it is determined that the component properties are in the reference relationship, the processing proceeds to step S1506, and the component of the processing target is displayed. On the other hand, in a case where it is determined that the component properties are not in the reference relationship, the component of the processing target is subjected to the non-display.

According to the processing in FIG. 15, the component of the processing target that is referred to by the other component of the hierarchy to which the component of the relation display target (the component specified in step S1002) belongs or the component of the lower hierarchy or refers to the other component of the hierarchy to which the component of the relation display target belongs or the component of the lower hierarchy, which is the determination of the display condition 4, can be extracted.

As described above, in the components included in the upper hierarchy or the lower hierarchy of the component of the relation display target, the component required to represent the outline of the processing or the relationship with the component to be subjected to relation display is extracted and displayed, in accordance with the display condition 1 to the display condition 4, and thus, the simple display can be attained.

According to this example, the user creating the automatic execution service is capable of switching the display mode such as the “normal display”, the “simple display”, and the “non-display” in accordance with the hierarchy, in relation to the hierarchy to which the component of the relation display target of which the reference relationship is planned to be grasped belongs, and is capable of checking the relation while looking down at the entire data processing flow.

Further, in the hierarchy to be subjected to the simple display, as the component to be displayed, the component required to grasp the outline of the processing in the data processing flow is extracted in accordance with the display condition 2 and the display condition 3, and the component required to grasp the reference relationship of the component of the relation display target is extracted in accordance with the display condition 1 and the display condition 4, and thus, only the processing required to grasp the relation can be extracted, and the relation of a large-scale and complicated content can also be easily checked.

<Application Example>

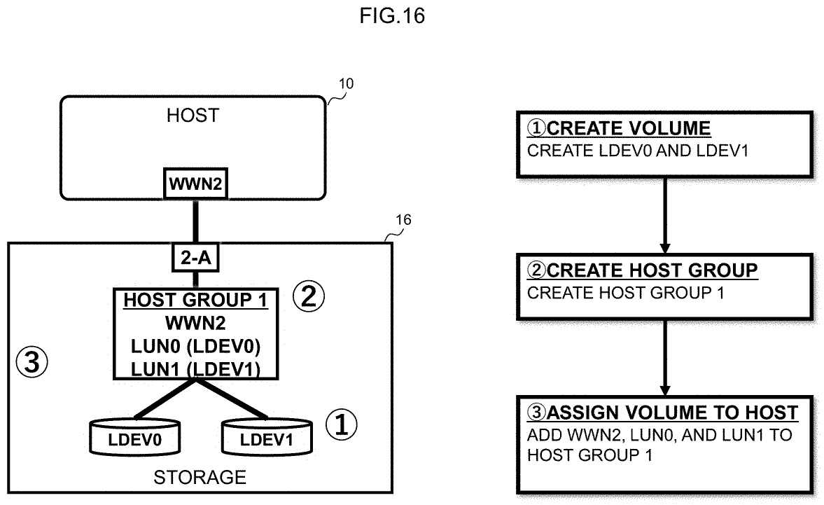

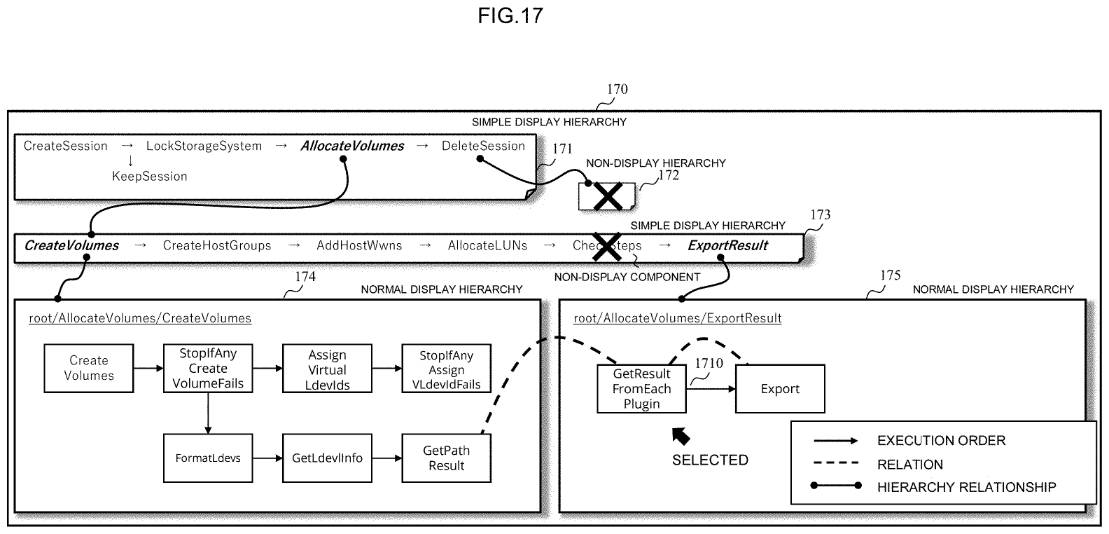

FIG. 16 and FIG. 17 illustrate an example to which this embodiment is applied.

FIG. 16 illustrates processing of creating a volume in the storage 16, of creating a host group, and of assigning the volume to the host, as the data processing flow (the automatic execution service), which is performed with respect to the storage 16 from the calculation management system 11, as an example.

First, the storage 16 creates the volumes of LDEV0 and LDEV1, in accordance with the command from the calculation management system 11. Next, the host group is created. Finally, the host of WWN2 is added to the created host group, and a LUN path corresponding to LDEV0 and LDEV1 is set.

FIG. 17 illustrates display in a case where this example is applied to the data processing flow of the automatic execution service illustrated in FIG. 16. The drawing illustrated in FIG. 17 is displayed on the display device of the input/output device 148 of the management client 14. The user creating the automatic execution service, for example, is capable of selecting the component of which the reference relationship is planned to be grasped (the component of the relation display target), from the data processing flow displayed on the display device. FIG. 17 is a diagram illustrating a result of performing the determination of the display mode such as the “normal display”, the “simple display”, and the “non-display”, and the extraction of the component to be displayed in the simple display with respect to each of the hierarchies in a case where a component 1710 is selected.

As illustrated in FIG. 17, in the case of grasping a reference relationship with the selected component 1710, in a root hierarchy 171 that is the uppermost hierarchy, a necessary component is extracted and is subjected to the simple display. In addition, an upper hierarchy 173 of the hierarchy to which the component 1710 belongs is also subjected to the simple display, as the simple display hierarchy.

On the other hand, the normal display is performed with respect to a hierarchy 175 to which the selected component 1710 belongs and a hierarchy 174 to which a component in a reference relationship with the selected component 1710 belongs, even though the hierarchies are a lower hierarchy.

In the upper hierarchy, a hierarchy 172 that is a hierarchy having no relationship after grasping the reference relationship of the selected component and has a noise even in the case of being displayed is subjected to the non-display.

Note that, the hierarchy 171 and the hierarchy 173 are subjected to the simple display by determining the display condition 1 to the display condition 4 for extracting a component that is capable of maintaining information of the outline of the processing and the relationship with the component of the relation display target. Unnecessary information is not displayed in order to understand the outline of the processing, and thus, the user is capable of checking the hierarchy relationship and the processing order relationship with less information, and is capable of checking the relation while looking down at the entire data processing flow.

When operation management is automated, the component has various functions such as data acquisition, data check, data shaping, the manipulation of the relevant product, output data generation, and the creation of the hierarchy. According to this example, among the components, a component that is closely relevant to the component of the relation display target (a hierarchy component forming the upper hierarchy or a component including processing relevant to a target component) or a component that is capable of grasping the outline of automation processing (a component manipulating the relevant product) can be extracted. That is, display can be performed by determining “which information is to be displayed in detail, and which information is less related”, on the basis of the properties of the automation of the operation management in an IT infrastructure.

In addition, in a case where information is dropped from a target that is displayed as the simple display, the outline of the data processing flow can be grasped, and the component required to represent the outline of the processing and the relationship with the component of the relation display target can be extracted by determining the display condition for displaying the component in the reference relationship with the component of the relation display target.

As described above, according to this example, it is possible to check the relation while looking down at the entire data processing flow.

In addition, according to this example, only the processing required to grasp the relation is extracted, and thus, even in the case of a large-scale and complicated automatic execution service, the relation can be easily checked.

The example described above has been described in detail in order to describe the present invention in a comprehensible manner, but is not necessarily limited to including all of the configurations described above.

Each of the configurations, the functions, the processing units, and the like described above may be attained by hardware, for example, by designing a part or all thereof as an integrated circuit. In addition, each of the configurations, the functions, and the like described above may be attained by using software by interpreting and executing a program for a processor to attain each of the functions.

Information such as a program, a table, and a file for attaining each of the functions can be stored in a recording device such as a memory, a hard disk, or a solid state drive (SSD), or a recording medium such as an IC card or a SD card.

What is claimed is:

1. An operation automation system of an automatic execution service, the system comprising:
an input/output device inputting information for specifying a component in a data processing flow in which a plurality of hierarchies that configure the automatic execution service and respectively include at least one component are configured in a multiple-stage hierarchical manner, as a component of a relation display target; and
a processor,
wherein the processor
selects a display mode for performing normal display with respect to a first hierarchy when a hierarchy of a processing target is the first hierarchy to which the component of the relation display target belongs, in the plurality of hierarchies configuring the data processing flow,
selects a display mode for performing simple display with respect to a second hierarchy when the hierarchy of the processing target is the second hierarchy to which a hierarchy component including a hierarchy to which the component of the relation display target belongs, in the plurality of hierarchies configuring the data processing flow, and
selects a display mode for performing non-display with respect to a third hierarchy when the hierarchy of the processing target is neither the first hierarchy to which the component of the relation display target belongs nor the second hierarchy to which the hierarchy component including the hierarchy to which the component of the relation display target belongs, but is the third hierarchy, in the plurality of hierarchies configuring the data processing flow.

2. The operation automation system according to claim 1,
wherein in the normal display, the data processing flow at the time of a service creation or after an edit of the data processing flow is displayed, and
in the simple display, a component required for indicating a hierarchy relationship with respect to the component of the relation display target and a processing order relationship with respect to the component of the relation display target is displayed by being extracted, in accordance with a display condition to be determined by the processor.

3. The operation automation system according to claim 1,
wherein the operation automation system further comprises a memory storing a component management table for managing the component and the hierarchy in association with each other, and a hierarchical management table for managing the hierarchy component for grouping the hierarchy and the hierarchy and a parent hierarchy to which the hierarchy component belongs in association with each other, and
the processor
determines whether or not the hierarchy of the processing target is the hierarchy to which the component of the relation display target belongs, on the basis of the component management table, and selects the display mode for performing the normal display with respect to the hierarchy to which the component of the relation display target belongs, as the first hierarchy, and
specifies the parent hierarchy of the first hierarchy as the second hierarchy, on the basis of the hierarchical management table, and selects the display mode for performing the simple display with respect to the second hierarchy.

4. The operation automation system according to claim 3,
wherein the processor
determines whether or not the component of the processing target is a component for grouping the first hierarchy to which the component of the relation display target belongs, as a first display condition, on the basis of the hierarchical management table, and
extracts the component to be displayed from the second hierarchy, in accordance with the first display condition.

5. The operation automation system according to claim 4,
wherein the component management table stored in the memory manages an execution file path in addition to the component and the hierarchy, in association with each other, and
the processor
determines whether or not the component of the processing target is connected to a relevant product, as a second display condition, on the basis of the component management table for managing the execution file path in association with the component and the hierarchy, and
extracts the component to be displayed from the second hierarchy, in accordance with the second display condition.

6. The operation automation system according to claim 5,
wherein the processor
determines whether or not a component belonging to a lower hierarchy grouped by the hierarchy component is connected to the relevant product when the component of the processing target is the hierarchy component including the lower hierarchy, as a third display condition, and
extracts the component to be displayed from the second hierarchy, in accordance with the third display condition.

7. The operation automation system according to claim 6,
wherein the memory stores a property reference table for specifying a reference relationship between the components, and
the processor
determines whether or not a property of the component of the processing target, a property of the other component of the first hierarchy to which the component of the relation display target belongs, and a property of the component belonging to the lower hierarchy of the first hierarchy are in the reference relationship, as a fourth display condition, on the basis of the property reference table, and
performs control such that a component in the reference relationship with the component of the relation display target is extracted and displayed, in accordance with the fourth display condition.

8. A display method of an automatic execution service, the method comprising:
allowing an input/output device to input information for specifying a component in a data processing flow in which a plurality of hierarchies that configure the automatic execution service and respectively include at least one component are configured in a multiple-stage hierarchical manner, as a component of a relation display target; and
allowing the input/output device to input information for specifying the component of the relation display target,
wherein a processor
selects a display mode for performing normal display with respect to a first hierarchy when a hierarchy of a processing target is the first hierarchy to which the component of the relation display target belongs, in the plurality of hierarchies configuring the data processing flow,
selects a display mode for performing simple display with respect to a second hierarchy when the hierarchy of the processing target is the second hierarchy to which a hierarchy component including a hierarchy to which the component of the relation display target belongs, in the plurality of hierarchies configuring the data processing flow, and
selects a display mode for performing non-display with respect to a third hierarchy when the hierarchy of the processing target is neither the first hierarchy to which the component of the relation display target belongs nor the second hierarchy to which the hierarchy component including the hierarchy to which the component of the relation display target belongs, but is the third hierarchy, in the plurality of hierarchies configuring the data processing flow.

9. The display method of an automatic execution service according to claim 8, further comprising:
storing a component management table for managing the component and the hierarchy in association with each other, and a hierarchical management table for managing the hierarchy component for grouping the hierarchy and the hierarchy and a parent hierarchy to which the hierarchy component belongs in association with each other, in a memory,
wherein the processor
determines whether or not the hierarchy of the processing target is the hierarchy to which the component of the relation display target belongs, on the basis of the component management table, and selects the display mode for performing the normal display with respect to the hierarchy to which the component of the relation display target belongs, as the first hierarchy, and
specifies the parent hierarchy of the first hierarchy as the second hierarchy, on the basis of the hierarchical management table, and selects the display mode for performing the simple display with respect to the second hierarchy.

10. The display method of an automatic execution service according to claim 9,
wherein the processor
determines whether or not the component of the processing target is a component for grouping the first hierarchy to which the component of the relation display target belongs, as a first display condition, on the basis of the hierarchical management table, and
extracts the component to be displayed from the second hierarchy, in accordance with the first display condition.

11. The display method of an automatic execution service according to claim 10,
wherein the component management table stored in the memory manages an execution file path in addition to the component and the hierarchy, in association with each other, and
the processor
determines whether or not the component of the processing target is connected to a relevant product, as a second display condition, on the basis of the component management table for managing the execution file path in association with the component and the hierarchy, and
extracts the component to be displayed from the second hierarchy, in accordance with the second display condition.

12. The display method of an automatic execution service according to claim 11,
wherein the processor
determines whether or not a component belonging to a lower hierarchy grouped by the hierarchy component is connected to the relevant product when the component of the processing target is the hierarchy component including the lower hierarchy, as a third display condition, and
extracts the component to be displayed from the second hierarchy, in accordance with the third display condition.

13. The display method of an automatic execution service according to claim 12,
wherein the memory stores a property reference table for specifying a reference relationship between the components, and
the processor
determines whether or not a property of the component of the processing target, a property of the other component of the first hierarchy to which the component of the relation display target belongs, and a property of the component belonging to the lower hierarchy of the first hierarchy are in the reference relationship, as a fourth display condition, on the basis of the property reference table, and
performs control such that a component in the reference relationship with the component of the relation display target is extracted and displayed, in accordance with the fourth display condition.
